(19) United States
(12) Patent Application Publication
(10) Pub. No.: US 2010/0189039 A1
(43) Pub. Date: Jul. 29, 2010

(54) DERIVATION OF LTE SYSTEM INFORMATION RETRANSMISSION REDUNDANCY VERSIONS

(75) Inventors: Peter S. Wang, East Setauket, NY (US); Guodong Zhang, Syosset, NY (US); Stephen E. Terry, Northport, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/691,852

(22) Filed: Jan. 22, 2010

Related U.S. Application Data
(60) Provisional application No. 61/146,773, filed on Jan. 23, 2009.

(51) Int. Cl. H04W 8/00

(52) U.S. Cl. 370/328

(57) ABSTRACT

A method and apparatus for transmitting system information in an e Node B includes a processor configured to map system information to a plurality of subframes, determine that at least one of the plurality of subframes includes non-SI information, and assign a redundancy version to all of the plurality of subframes except the at least one subframe including non-SI information such that the redundancy versions are assigned in a particular pattern and the at least one subframe including non-SI information does not effect the particular pattern.

### CROSS REFERENCE TO RELATED APPLICATION

This application claims the benefit of U.S. Provisional Application No. 61/146,773, filed Jan. 23, 2009, which is incorporated by reference as if fully set forth herein.

### FIELD OF INVENTION

This application is related to wireless communications.

### BACKGROUND

Efficient operation of a wireless communication network may depend upon error free and efficient reception of system information messages by a wireless transmit/receive unit (WTRU). A base station, such as an evolved Node B (eNodeB), for example, may broadcast one or more system information (SI) messages in a time period consisting of a few subframes. The time period may be referred to as an SI-window. The messages may be transmitted with an error checking and correction scheme, such as hybrid automatic repeat request (HARQ).

### SUMMARY

A method and apparatus are disclosed for transmitting system information in an eNodeB. This may include a processor configured to map system information to a plurality of subframes, determine that at least one of the plurality of subframes includes non-SI information, and assign a redundancy version to all of the plurality of subframes except the at least one subframe including non-SI information such that the redundancy versions are assigned in a particular pattern and the at least one subframe including non-SI information does not effect the particular pattern.

### BRIEF DESCRIPTION OF THE DRAWINGS

A more detailed understanding may be had from the following description, given by way of example in conjunction with the accompanying drawings wherein:

FIG. 1 shows an overview of an Evolved Universal Mobile Telecommunications System (UMTS) Terrestrial Radio Access Network (E-UTRAN);

FIG. 2 shows a wireless communication system including a plurality of wireless transmit receive units (WTRUs) and an e Node B (eNB);

FIG. 3 is a functional block diagram of the WTRU and the eNB of the wireless communication system of FIG. 2;

FIG. 4 shows a sequence of redundancy version (RV) numbers in accordance with the prior art;

FIG. 5 shows a system information (SI)-window with non-SI subframes in accordance with the prior art;

FIG. 6 shows a method of transmitting sub-frames in an SI-window in accordance with an embodiment.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment. Although the embodiments set forth herein may be presented in terms of a particular wireless technology, such as LTE, GERAN and/or GSM, for example, the methods and apparatus disclosed herein are not so limited, and may be applicable to any wireless or wired communication network.

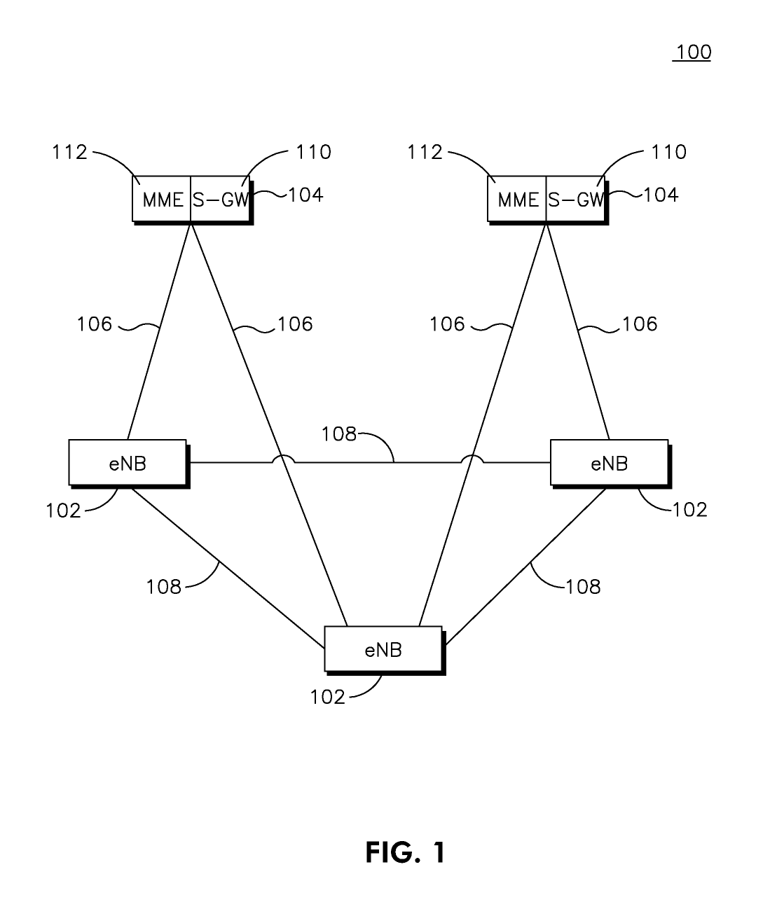

FIG. 1 shows an overview of an Evolved Universal Mobile Telecommunications System (UMTS) Terrestrial Radio Access Network (E-UTRAN) 100 in accordance with the prior art. As shown in FIG. 1, E-UTRAN 100 includes three eNodeBs (eNBs) 102, however, any number of eNBs may be included in E-UTRAN 100. The eNBs 102 are interconnected by an X2 interface 108. The eNBs 102 are also connected by an S1 interface 106 to the Evolved Packet Core (EPC) 104. The EPC 104 includes a Mobility Management Entity (MME) 112 and a Serving Gateway (S-GW) 110.

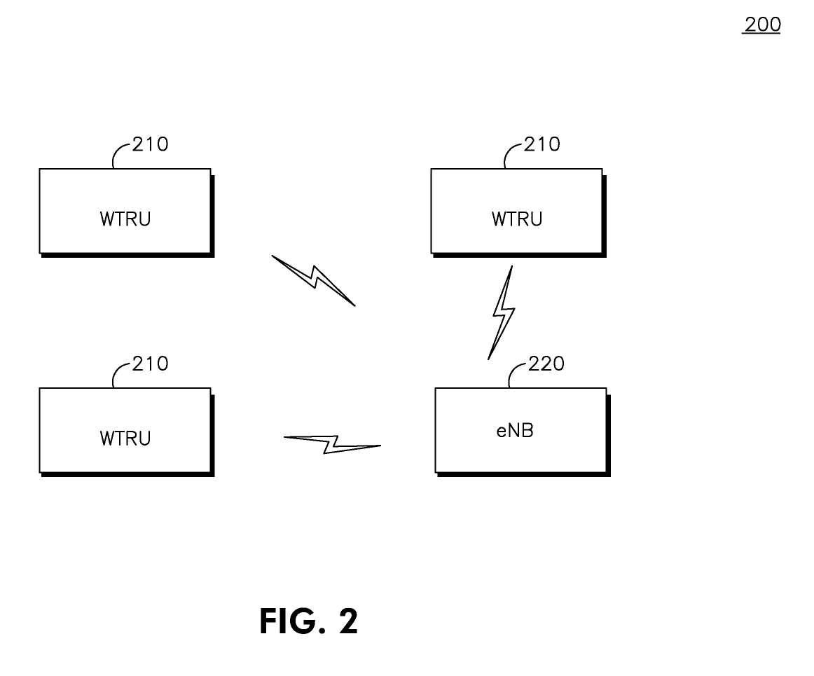

In a wireless communication system, a wireless transmit receive unit (WTRU) may communicate with an e Node-B (eNB). FIG. 2 shows a wireless communication system 200 including a plurality of WTRUs 210 and an e Node B (eNB) 220. As shown in FIG. 2, the WTRUs 210 are in communication with the eNB 220. Although three WTRUs 210 and one eNB 220 are shown in FIG. 2, it should be noted that any combination of wireless and wired devices may be included in the wireless communication system 200.

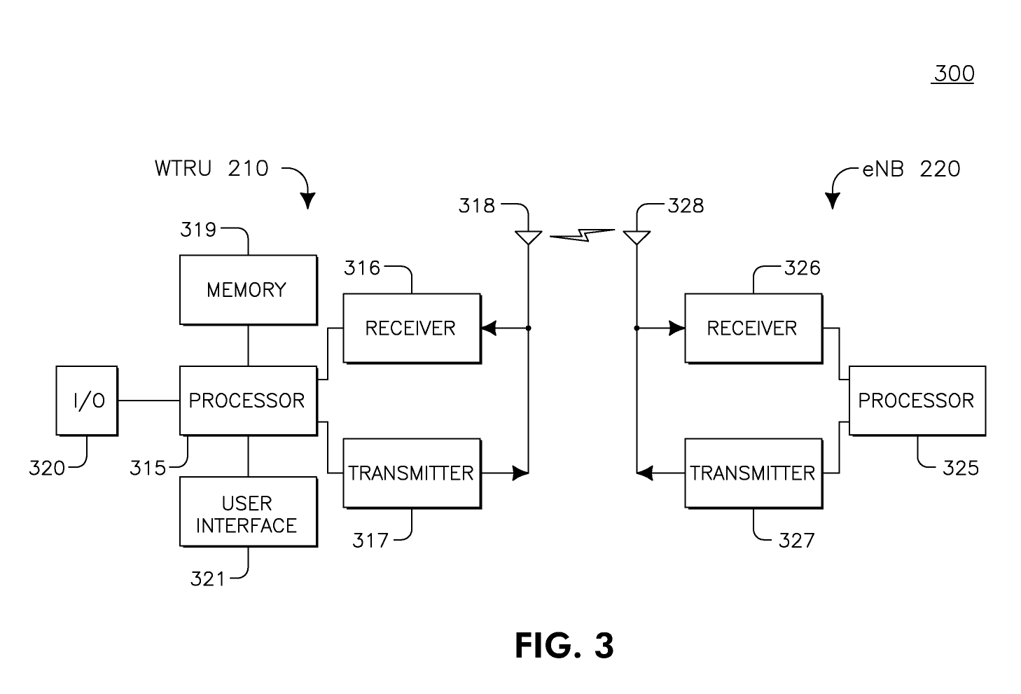

FIG. 3 is a functional block diagram 300 of the WTRU 210 and the eNB 220 of the wireless communication system 200 of FIG. 2. As shown in FIG. 2, the WTRU 210 is in communication with the eNB 220. The WTRU 210 is configured to receive and process system information messages as required. The WTRU 210 is further configured to receive and process HARQ transmissions and retransmissions.

In addition to the components that may be found in a typical WTRU, the WTRU 210 includes a processor 315, a receiver 316, a transmitter 317, and an antenna 318. The WTRU 210 may also include a user interface 321, which may include, but is not limited to, an LCD or LED screen, a touch screen, a keyboard, a stylus, or any other typical input/output device. The WTRU 310 may also include memory 319, both volatile and non-volatile as well as interfaces 320 to other WTRUs, such as USB ports, serial ports and the like. The receiver 316 and the transmitter 317 are in communication with the processor 315. The antenna 318 is in communication with both the receiver 316 and the transmitter 317 to facilitate the transmission and reception of wireless data.

In addition to the components that may be found in a typical eNB, the eNB 220 includes a processor 325, a receiver 326, a transmitter 327, and an antenna 328. The receiver 326 and the transmitter 327 are in communication with the processor 325. The antenna 328 is in communication with both the receiver 326 and the transmitter 327 to facilitate the transmission and reception of wireless data.

One of the ways the eNB can inform the WTRU about operating parameters is for the eNB to transmit system information to the WTRU. System information is public information about how a WTRU communicates with a cell, such as transmission bandwidth, channel configurations, cell loading and power control parameters, for example.

There may be a relatively large amount of system information transmitted by an eNB in a cell. Therefore, in order to organize the transmission of the system information, the information may be divided into a number of system information blocks (SIBs). The types of system information carried in a particular SIB is constant, but the value of the information carried in each SIB is subject to change.

An SI-window is a period of time during which an eNB may broadcast an SIB or an SI message (hereinafter, “SI”). The SI may be an aggregation of SIBs. An SI-window may span one or more sub-frames as determined by, for example, the eNB. Within each SI-window, SI may be transmitted a number of times in any sub-frame, with some exceptions. For example, SI may not be broadcast in a sub-frame that is carrying multicast/broadcast over single frequency network (MBSFN) information, uplink sub-frames in time division duplex (TDD) if the WTRU is operating in TDD mode, or a particular SIB with a fixed schedule, such as SIB-1, for example. Other types of data may also preempt normal SI transmission.

SI may be transmitted using a hybrid automatic repeat request (HARQ) transmission scheme. A HARQ transmission scheme may use a redundancy encoding technique; that is, additional bits known as redundancy bits may be generated from the original data content. The redundancy bits may be transmitted with, or after, the original content. The redundancy bits are used to help the receiving decoder in a WTRU, for example, correct errors that may occur when the original data is received. A redundancy version (RV) represents a particular combination of original bits and redundant bits in HARQ operation and may specify a particular arrangement of the bits. Different RV's may be used in a communication system, but only one RV may be used per subframe.

An RV number represents a particular RV. The RV number may be explicitly signaled to the WTRU from, for example, an eNB. Alternatively, the RV number may be derived by the WTRU using, for example, an absolute or relative subframe number. When the WTRU reads a communication channel, such as the broadcast control channel (BCCH), for example, the WTRU may use scheduling information received in a downlink message, such as a radio resource control (RRC) message, for example. The WTRU may then use the scheduling information to receive a downlink assignment for a transmission time interval (TTI). The downlink assignment may be received on a downlink channel, such as the physical downlink control channel (PDCCH), for example. The redundancy version of the received downlink assignment for the TTI may be determined by the equation:

$${RV}_{k} = ⌈ \frac{3}{2} k ⌉ mod 4 , \qquad ( Equation 1 )$$

where RVₖ is the RV of the k^{th} message. In Equation 1, k may depend on the type of system information message. For example, for an SIB-1 message, k=(SFN/2) modulo 4, where SFN is the system frame number. For other SI, k=i mod 4, i=0, 1, . . . , nₛ^{w}−1, where nₛ^{w} is number of subframes in the SI window.

An RV sequence (RVS) is a pattern, or sequence of RVs that may be used for a string of subframes. For most SI, excluding SI transmissions with a fixed schedule, such as SIB-1, a redundancy version sequence (RVS) of 0, 2, 3, 1, 0, 2, 3, 1 . . . may be used to provide optimal processing gain in a HARQ procedure with respect to reception and decoding of the received data.

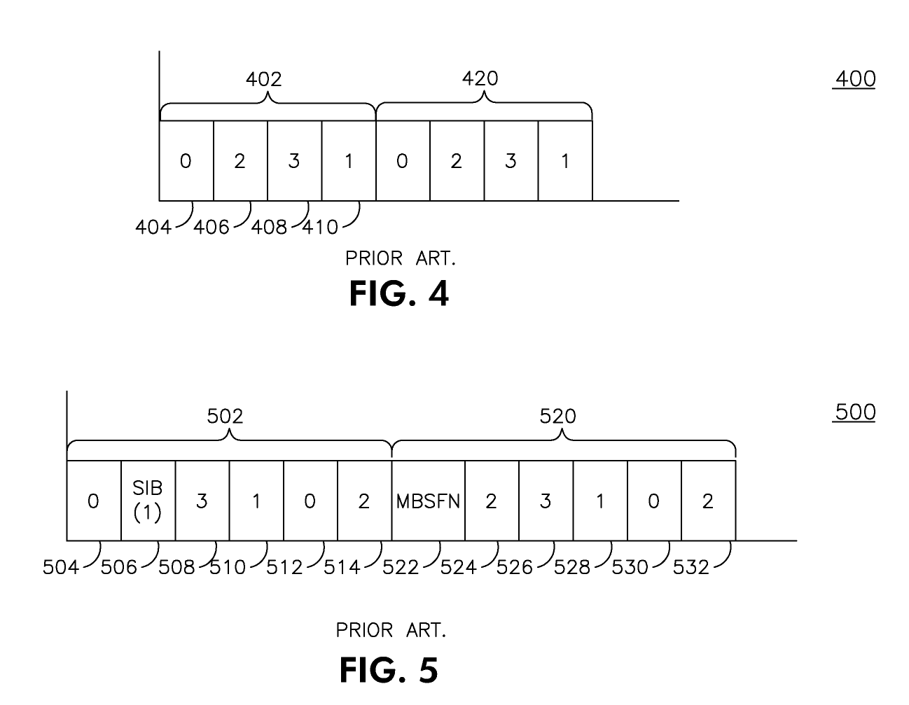

FIG. 4 shows an RVS 400 in accordance with the prior art. The RVS 400 of FIG. 4 is 0, 2, 3, 1. In a first SI-window 402 there are four (4) subframes (404, 406, 408, 410). The first subframe 404 is associated with RV0, the second subframe 406 with RV2, the third subframe 408 with RV3 and the fourth subframe 410 with RV1. The RV sequence shown in the first SI-window 402 is repeated in the second SI-window 420.

When the system becomes more complex, there may be sub-frames inside each SI-window that do not carry an SI message, but are used for other purposes. FIG. 5 shows an SI-window with non-SI subframes 500 in accordance with the prior art. The first SI-window 502 and the second SI-window 520 each include six (6) subframes. The first subframe 504 includes SI information and is associated with RV0. The second subframe 506 includes a SIB-1 transmission, which preempts the SI message transmission. The third subframe 508 includes SI information and is associated with RV3. The fourth subframe 510 includes SI information and is associated with RV1. The fifth subframe 512 includes SI information and is associated with RV0. The sixth subframe 514 includes SI information and is associated with RV2.

The second SI-window 520 includes a first subframe 522 that includes MBSFN information. The MBSFN information preempts the SI information in the subframe. The second subframe 524 includes SI-information and is associated with RV2. The third subframe 526 includes SI information and is associated with RV3. The fourth subframe 528 includes SI information and is associated with RV1. The fifth subframe 530 includes SI information and is associated with RV0. The sixth subframe 532 includes SI information and is associated with RV2.

For the sub-frames that include non-SI information, such as the second subframe 506 and the first subframe 522 in FIG. 5, the SI information, with its appropriate RV version of the content cannot be scheduled and transmitted. A redundancy version, such as RV1, RV2 or RV3 or a critical original version of a HARQ transmission, such as RV0, may be missing.

In the first SI-window 502, the scheduled SIB-1 transmission in the second subframe 506 preempts the RV2 retransmission, so the WTRU's reception of the first SI will be the first subframe 504 (RV0) and the retransmission of in the third subframe 508 (RV3) and so on. The recombination of SI information received in the first subframe 504 (RV0) with the SI information received in the third subframe 508 (RV3) may be inefficient because the second subframe 506 does not include SI information and RV2 is missing. This may affect the WTRU's power consumption due to a longer SI reception time.

In the second SI-window 520, the first subframe 522 with MBSFN information preempts the first subframe, thus the original SI transmission with RV0 is missing. Even though the WTRU may attempt to decode subsequent retransmissions, the reception performance may be degraded because of the missing RV0 subframe.

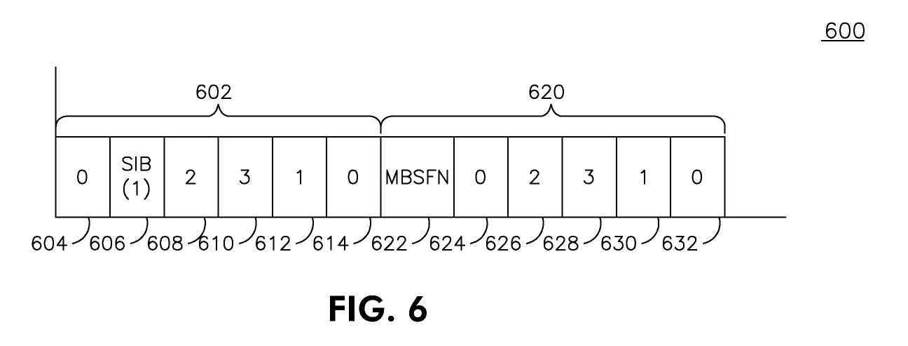

FIG. 6 shows a method of transmitting sub-frames in an SI-window in accordance with an embodiment. The first SI-window 602 includes six (6) subframes. The first subframe 604 includes SI information and is associated with RV0. The second subframe 606 includes a SIB-1 transmission, which preempts the SI message transmission. As the eNB maps RVs to the subframes in the first SI-window 602, the eNB may skip the second subframe 606 as it applies the mapping equation (equation 1). The third subframe 608 includes SI information and is associated with RV3. The fourth subframe 610 includes SI information and is associated with RV1. The fifth subframe 612 includes SI information and is associated with RV0. The sixth subframe 614 includes SI information and is associated with RV2.

The second SI-window 620 includes a first subframe 622 that includes MBSFN information. The MBSFN information preempts the SI information in the first subframe 622. As the eNB maps RVs to the subframes in the second SI-window 620, the eNB may skip the first subframe 622 as it applies the mapping equation (Equation 1). The second subframe 624 includes SI-information and is associated with RV0. The third subframe 626 includes SI information and is associated with RV2. The fourth subframe 628 includes SI information and is associated with RV3. The fifth subframe 630 includes SI information and is associated with RV1. The sixth subframe 632 includes SI information and is associated with RV0.

In order to obtain the RV distribution shown in FIG. 6, when applying the formula for RV computation to the SI-window, subframes that preempt the SI sub-frames may not be included in subframe K in the RV derivation formula. Therefore, the RV may be computed as:

RV_{K}=ceiling(3/2*k)mod 4 (Equation 2),

where k=i modulo 4, i=0, 1, . . . , nₛ^{w}−1, i denotes the subframe number within the SI window nₛ^{w}, excluding the non SI subframes.

Furthermore, one priority of the eNB may be to not configure any of the non-SI subframes into the first subframe of any SI-window so as not to block the first HARQ transmission of the original SI contents with RV0. However, if the first subframe within a SI-window is blocked by any non-SI subframe, the eNB may start transmitting the SI message with RV0 in the first SI subframe while the WTRU may start the counting of the subframe number i from the first SI subframe in the SI-window. The RV may be computed as:

RV_{K}=ceiling (3/2*k)modulo 4, where k=i modulo 4, i=0, 1, . . . , nₛ^{w}−1, i denotes the subframe number within the SI window nₛ^{w}, starting from the first SI subframe within the SI-window.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method of transmitting system information in an e Node B (eNB), the method comprising:
mapping system information to a plurality of subframes;
determining that at least one of the plurality of subframes includes non-SI information; and
assigning a redundancy version to all of the plurality of subframes except the at least one subframe including non-SI information such that the redundancy versions are assigned in a particular pattern and the at least one subframe including non-SI information does not effect the particular pattern.

2. The method as in claim 1 further comprising assigning a first redundancy version to a first subframe containing SI information.

3. The method as in claim 1 wherein the plurality of subframes comprise a first SI window.

4. The method as in claim 1 further comprising determining a redundancy version of each of the plurality of subframes based on the subframe number of the subframe.

5. The method as in claim 1 further comprising:
determining that a first sub-frame includes non-SI information;
determining that a next sub-frame includes SI information; and
assigning a first RV to the next sub-frame.

6. An e Node B (eNB) comprising a processor, the processor configured to:
map system information to a plurality of subframes;
determine that at least one of the plurality of subframes includes non-SI information; and
assign a redundancy version to all of the plurality of subframes except the at least one subframe including non-SI information such that the redundancy versions are assigned in a particular pattern and the at least one subframe including non-SI information does not effect the particular pattern.

7. The eNB as in claim 6 wherein the processor is further configured to assign a first redundancy version to a first subframe containing SI information.

8. The eNB as in claim 6 wherein the plurality of subframes comprise a first SI window.

9. The eNB as in claim 6 wherein the processor is further configured to determine a redundancy version of each of the plurality of subframes based on the subframe number of the subframe.

10. The eNB as in claim 6 wherein the processor is further configured to:
determine that a first sub-frame includes non-SI information;
determine that a next sub-frame includes SI information; and
assign a first RV to the next sub-frame.
